(19) United States
(12) Patent Application Publication
(10) Pub. No.: US 2024/0166940 A1
(43) Pub. Date: May 23, 2024

(54) INTERNAL BREAKERS ENCAPSULATED BY CALCIUM CARBONATE FORMED FROM SEQUESTERED CARBON DIOXIDE

(71) Applicant: Chevron U.S.A. Inc., San Ramon, CA (US)

(72) Inventor: Sandra Liliana Gomez-Nava, Katy, TX (US)

(21) Appl. No.: 18/056,473

(22) Filed: Nov. 17, 2022

(51) Int. Cl. C09K 8/70

(52) U.S. Cl. CPC C09K 8/706

(57) ABSTRACT

A wellbore fluid composition comprises synthetic calcium carbonate coated internal breaker particles. The synthetic calcium carbonate coated internal breaker particles comprise substrate particles, each of the substrate particles comprising an oxidizer. The substrate particles have a coating of synthetic calcium carbonate surrounding each of the substrate particles. The coating of synthetic calcium carbonate is formed by contacting an ammoniated aqueous solution with a carbon dioxide source producing a carbonated ammoniated aqueous solution, and contacting the carbonated ammoniated aqueous solution with the substrate particles to produce the composition of synthetic calcium carbonate coated internal breaker particles.

### TECHNICAL FIELD

Embodiments of the technology relate generally to wellbore fluid internal breakers that are encapsulated in calcium carbonate formed from sequestered carbon dioxide.

### BACKGROUND

Wells are drilled into land and subsea formations for various purposes, including producer wells that produce resources such as water and hydrocarbons (e.g., petroleum and natural gas), and injector wells used to place fluids (e.g., water, wastewater, carbon dioxide gas, chemicals, hydrocarbons) underground into formations. While a well is being drilled, various types of drilling fluids can be used to facilitate the drilling, to remove cuttings created by the drilling, and to protect the formation surrounding the well. Drilling a well typically involves drilling through upper layers of a formation before reaching the target formation layers, which are the reservoir formations from which hydrocarbons are extracted or injection zones of formations into which fluids are injected. Drilling through the target formations (reservoir or injection zones) requires particular care so as not to damage the formation pores. Drill-in fluids are particular types of drilling fluids used during the portion of the drilling passing into the reservoir or injection formations. Drill-in fluids are compositions that include particles used to form a filter cake along the face of the formation exposed to the well. The filter cake protects the formation by controlling the invasion of drilling fluid components into the formation. Filter cake formed by drill-in fluid are designed to minimize any potential formation damage which may impact the subsequent production of reservoir fluids or injection of fluids.

In addition to drill-in fluids, other wellbore fluids associated with other processes also can be used to form a filter cake along the face of the formation exposed to the well or against sand control screens or proppant packs. For example, fluid loss control pills used during well completion and workover operations can include particles used to form a filter cake that inhibits the flow of fluid between the well and the formation or in some cases between the work string and the sand control screens or the proppant pack.

After a well is drilled, completed or worked over, the filter cake is removed to produce the resources from the reservoir zones or to place fluids in selected formation injection zones. The filter cake is typically removed by applying an acid or other chemical treatments to dissolve the filter cake. In advance of the treatment, internal breaker particles can be suspended within the drill-in fluid or fluid loss control pills so that the internal breaker particles are embedded in the filter cake that forms along the face of the formation. The internal breaker particles embedded in the filter cake can include materials that are released during the acid or chemical treatment and that assist in breaking down and removing the filter cake.

Improvements to internal breaker particles used in wellbore fluids, such as drill-in fluids, fluid loss control pills, and workover fluids, are described in the following description and attached drawings.

### SUMMARY

In one example embodiment, the present disclosure is generally directed to a method of making synthetic calcium carbonate coated internal breaker particles for use in a wellbore fluid composition. The method comprises contacting an ammoniated aqueous solution with a carbon dioxide source producing a carbonated ammoniated aqueous solution; and contacting the carbonated ammoniated aqueous solution with substrate particles to produce synthetic calcium carbonate coated internal breaker particles, wherein the substrate particles comprise an oxidizer and are coated with synthetic calcium carbonate.

The foregoing method can further include one or more of the following aspects. The synthetic calcium carbonate coated internal breaker particles can be combined with a base fluid, a viscosifier, a fluid loss control agent, weighting agents, and a pH control agent (e.g., one of magnesium oxide, sodium hydroxide, and potassium hydroxide) to produce the wellbore fluid composition. The synthetic calcium carbonate coated internal breaker particles can be present in the wellbore fluid composition at a concentration within a range of 0.5 to 5.0 lb/bbl and more preferably in a range of 0.5 to 2.0 lb/bbl. The substrate particles can further comprise an acid-soluble or self-degrading material, such as one or more of: a) synthetic calcium carbonate, b) a naturally occurring mineral, and c) a self-degrading polymeric material. The substrate particles can additionally comprise a protective coating surrounding the oxidizer. In some cases, the protective coating can withstand temperatures within a range of 250 degrees F. to 400 degrees F. In the foregoing method, the oxidizer can be activated when the synthetic calcium carbonate coated internal breaker particles are exposed to an acid.

In another example embodiment, the present disclosure is directed to a composition of synthetic calcium carbonate coated internal breaker particles comprising: substrate particles wherein each of the substrate particles comprises an oxidizer; and a coating of synthetic calcium carbonate surrounding each of the substrate particles. The coating of synthetic calcium carbonate can be formed by: contacting an ammoniated aqueous solution with a carbon dioxide source producing a carbonated ammoniated aqueous solution; and contacting the carbonated ammoniated aqueous solution with the substrate particles to produce the composition of synthetic calcium carbonate coated internal breaker particles.

The foregoing composition can further comprise one or more of the following aspects. The composition of synthetic calcium carbonate coated internal breaker particles can be a constituent of a wellbore fluid, the wellbore fluid composition further comprising: a base fluid, a viscosifier, a fluid loss control agent, weighting agents, and a pH control agent (e.g., one of magnesium oxide, sodium hydroxide, and potassium hydroxide). The synthetic calcium carbonate coated internal breaker particles can be present in the wellbore fluid composition at a concentration within a range of 0.5 to 5.0 lb/bbl and more preferably in a range of 0.5 to 2.0 lb/bbl. The substrate particles can further comprise an acid-soluble or self-degrading material, such as one or more of: a) synthetic calcium carbonate, b) a naturally occurring mineral, and c) a self-degrading polymeric material. The substrate particles can additionally comprise a protective coating surrounding the oxidizer. In some cases, the protective coating can withstand a temperature within a range of 250 degrees F. to 400 degrees F. when the wellbore fluid composition is pumped into a well. The oxidizer of the synthetic calcium carbonate coated internal breaker particles can be activated when the synthetic calcium carbonate coated internal breaker particles are exposed to an acid.

In yet another example embodiment, the present disclosure is directed to a method of protecting a formation during an operation on a well. The method can comprise: forming a blend of calcium carbonate particles produced from captured carbon dioxide, wherein at least a portion of the blend of calcium carbonate particles are synthetic calcium carbonate coated internal breaker particles formed from captured carbon dioxide; combining the blend of calcium carbonate particles with a base fluid, a weighting agent, a viscosifier, and a fluid loss control agent to produce a wellbore fluid composition; and pumping the wellbore fluid composition into the well to a location adjacent to a reservoir zone of the formation.

The foregoing method can further include one or more of the following aspects. The wellbore fluid composition can form a filter cake on a wellbore face of the formation. The synthetic calcium carbonate coated internal breaker particles can comprise a substrate coated with synthetic calcium carbonate, wherein the substrate comprises an oxidizer. The foregoing method can further comprise pumping an acid composition into the well, wherein the acid composition dissolves the synthetic calcium carbonate and releases the oxidizer from the synthetic calcium carbonate coated internal breaker particles. The substrate particles can further comprise an acid-soluble or self-degrading material, such as one or more of: a) synthetic calcium carbonate, b) a naturally occurring mineral, and c) a self-degrading polymeric material. The synthetic calcium carbonate coated internal breaker particles can have a protective coating that can withstand a temperature within a range of 250 degrees F. to 400 degrees F. when the wellbore fluid composition is pumped into a well.

The foregoing embodiments are non-limiting examples and other aspects and embodiments will be described herein. The foregoing summary is provided to introduce various concepts in a simplified form that are further described below in the detailed description. This summary is not intended to identify required or essential features of the claimed subject matter nor is the summary intended to limit the scope of the claimed subject matter.

### BRIEF DESCRIPTION OF THE DRAWINGS

The accompanying drawings illustrate only example embodiments relating to methods and compositions for synthetic calcium carbonate coated internal breaker particles used in wellbore fluids and therefore are not to be considered limiting of the scope of this disclosure. The principles illustrated in the example embodiments of the drawings can be applied to alternate methods and compositions. Additionally, the elements and features shown in the drawings are not necessarily to scale, emphasis instead being placed upon clearly illustrating the principles of the example embodiments. Certain dimensions or positions may be exaggerated to help visually convey such principles. In the drawings, the same reference numerals used in different embodiments designate like or corresponding, but not necessarily identical, elements.

FIG. 1A illustrates a method of producing a wellbore fluid composition comprising synthetic calcium carbonate coated internal breaker particles in accordance with an example embodiment of the disclosure.

FIG. 1B illustrates a synthetic calcium carbonate coated internal breaker particle produced using the method of FIG. 1A in accordance with an example embodiment of the disclosure.

FIG. 2A illustrates a method of producing a wellbore fluid composition comprising synthetic calcium carbonate coated internal breaker particles in accordance with an example embodiment of the disclosure.

FIG. 2B illustrates a synthetic calcium carbonate coated internal breaker particle produced using the method of FIG. 2A in accordance with an example embodiment of the disclosure.

FIG. 3 illustrates a well drilled with a wellbore fluid composition comprising synthetic calcium carbonate coated internal breaker particles in accordance with an example embodiment of the disclosure.

FIG. 4 illustrates a method of drilling a well with a wellbore fluid composition comprising synthetic calcium carbonate coated internal breaker particles in accordance with an example embodiment of the disclosure.

FIG. 5 illustrates a method of completing a well with a wellbore fluid composition comprising synthetic calcium carbonate coated internal breaker particles in accordance with an example embodiment of the disclosure.

### DETAILED DESCRIPTION OF EXAMPLE EMBODIMENTS

The example embodiments discussed herein are directed to compositions and methods for forming and using wellbore fluids comprising synthetic calcium carbonate coated internal breaker particles formed from sequestered carbon dioxide. Conventional calcium carbonate particles are a common bridging and weighting additive used in wellbore fluid compositions, including drill-in fluids, fluid loss control pills, and workover fluids. Conventional calcium carbonate particles can form a filter cake along the wellbore face. The filter cake protects the formation by controlling the invasion of drilling fluid components into the formation. Filter cake formed from drill-in-fluid is designed to minimize any potential formation damage which may impact the subsequent production of reservoir fluids or injectivity of fluids. Once the drilling, completion, or workover operation is completed, the calcium carbonate particles are also advantageous because they can be dissolved and removed with an acid or chemical treatment so that the filter cake does not obstruct production of the resource from the reservoir into the well. Conventional calcium carbonate particles are typically extracted from naturally occurring sources such as limestone, dolomite, and marble natural rock formations. After the naturally occurring calcium carbonate ores are mined, the ores undergo a grinding process to produce calcium carbonate particles of the desired size for use in drill-in fluids. In some cases, the calcium carbonate particles are mixed with other materials to achieve the desired weighting and bridging properties. Alternatives to calcium carbonate particles that have been used in wellbore fluids include rock salt, evaporated salt, soluble resins, and polylactic acid. However, calcium carbonate particles remain as a dominant choice for wellbore fluids.

One disadvantage of using naturally occurring calcium carbonate in wellbore fluids is that the mining and processing of the calcium carbonate is a lengthy process that requires substantial amounts of energy. The mining equipment, transport vehicles, and grinding equipment use a substantial amount of energy and such use typically generates carbon dioxide that is emitted into the atmosphere.

There have been a variety of efforts throughout various industries to reduce the amount of carbon dioxide released into the atmosphere. One method for reducing the amount of carbon dioxide emitted into the atmosphere is to capture carbon dioxide released during various activities and to sequester the carbon dioxide. Sequestered carbon dioxide can be stored using a variety of techniques. One technique involves combining the sequestered carbon dioxide with an aqueous solution to produce calcium carbonate, thereby sequestering the captured carbon dioxide in the produced calcium carbonate. Calcium carbonate produced from sequestered carbon dioxide can be referred to herein as synthetic calcium carbonate to distinguish it from the naturally occurring calcium carbonate that is mined and used in the conventional calcium carbonate particles traditionally used in wellbore fluid compositions. New applications that substitute synthetic calcium carbonate containing captured carbon dioxide in place of naturally occurring calcium carbonate provide additional opportunities to reduce the amount of carbon dioxide released into the atmosphere.

In addition to use as a bridging and weighting additive in wellbore fluid compositions, calcium carbonate can be used in connection with internal breaker particles. As explained above, internal breaker particles are suspended in a wellbore fluid so that they are pumped with the wellbore fluid into the well and become embedded in the filter cake that attaches to the formation along the wellbore face. The internal breaker particles typically comprise an oxidizer encapsulated within a protective coating. The protective coating is typically a polymer that prevents the oxidizer from interacting with the wellbore fluid or filter cake until desired. When it is time to breakdown and remove the filter cake, an acid or chemical treatment applied to the filter cake can dissolve the protective coating thereby releasing the oxidizer within the internal breaker particles. Once released, the oxidizer can react with the other particles of the filter cake to facilitate breaking down and removing the filter cake. Calcium carbonate can be used as an alternative to a polymer for the protective coating encapsulating the oxidizer. Therefore, the benefits associated with synthetic calcium carbonate can be extended to internal breaker particles. In other words, synthetic calcium carbonate containing sequestered carbon dioxide can be used to encapsulate the oxidizer when forming the internal breaker particles.

The example embodiments described herein can provide applications for using synthetic calcium carbonate to form internal breaker particles. These applications provide multiple advantages. First, the energy used and the associated carbon dioxide emitted in connection with making the traditional polymer coating used in conventional internal breaker particles can be reduced. Second, carbon dioxide emitted from other processes involving fossil fuel combustion or the carbon dioxide already present in the atmosphere can be captured and sequestered in the synthetic calcium carbonate used to encapsulate the oxidizer in internal breaker particles. When the synthetic calcium carbonate sequesters carbon dioxide from the atmosphere or from a combustion process, the internal breaker particles can lock up carbon dioxide that would otherwise add to the total carbon dioxide in the atmosphere. Thus, reducing costs and carbon dioxide emissions by replacing the polymer coating of conventional internal breaker particles with synthetic calcium carbonate provides significant benefits. These benefits can be further maximized when the synthetic calcium carbonate formed from sequestered carbon dioxide can be formed at or near the wells where it is to be used.

Therefore, given the foregoing benefits, internal breaker particles provide a valuable opportunity for using synthetic calcium carbonate. As will be described further in the following examples, the methods and apparatus described herein improve upon prior art approaches to producing and using internal breaker particles in hydrocarbon wells.

As used herein, the terms “sequestered carbon dioxide” and “captured carbon dioxide” refer to the process of gathering carbon dioxide from the atmosphere or directly from a combustion process, combining the carbon dioxide with an aqueous solution, and producing calcium carbonate that traps the carbon dioxide in a solid compound.

As used herein, the term “wellbore fluid” refers to any of a variety of fluids that are pumped into a well, including but not limited to drill-in fluid, fluid loss control pills, and workover fluids.

In the following paragraphs, particular embodiments will be described in further detail by way of example with reference to the drawings. In the description, well-known components, methods, and/or processing techniques are omitted or briefly described. Furthermore, reference to various feature(s) of the embodiments is not to suggest that all embodiments must include the referenced feature(s).

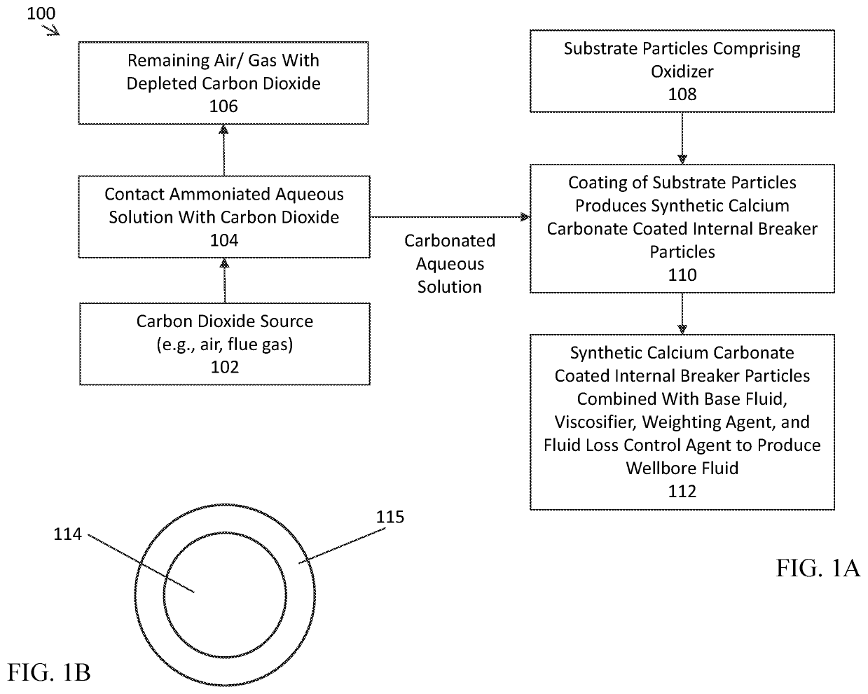

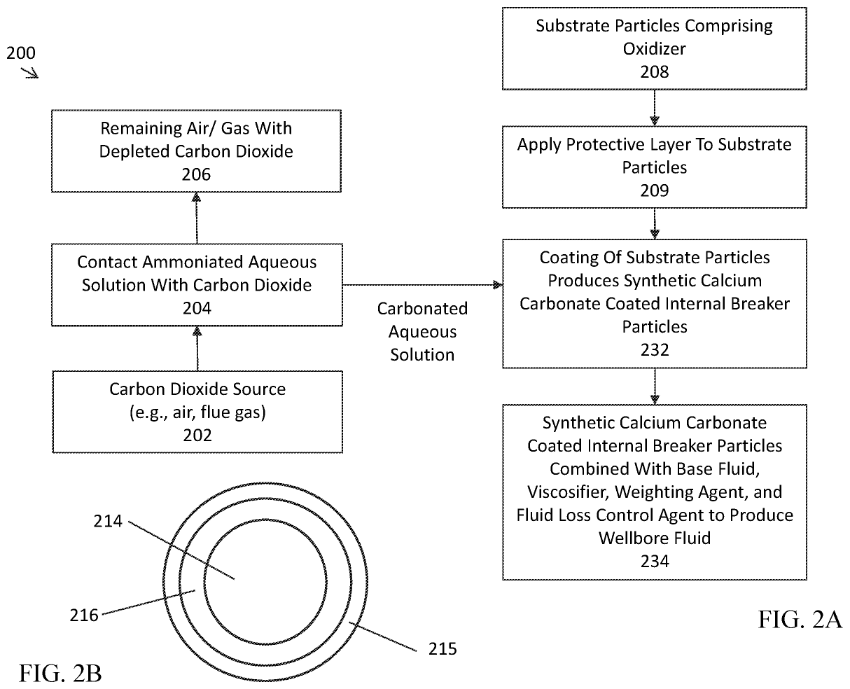

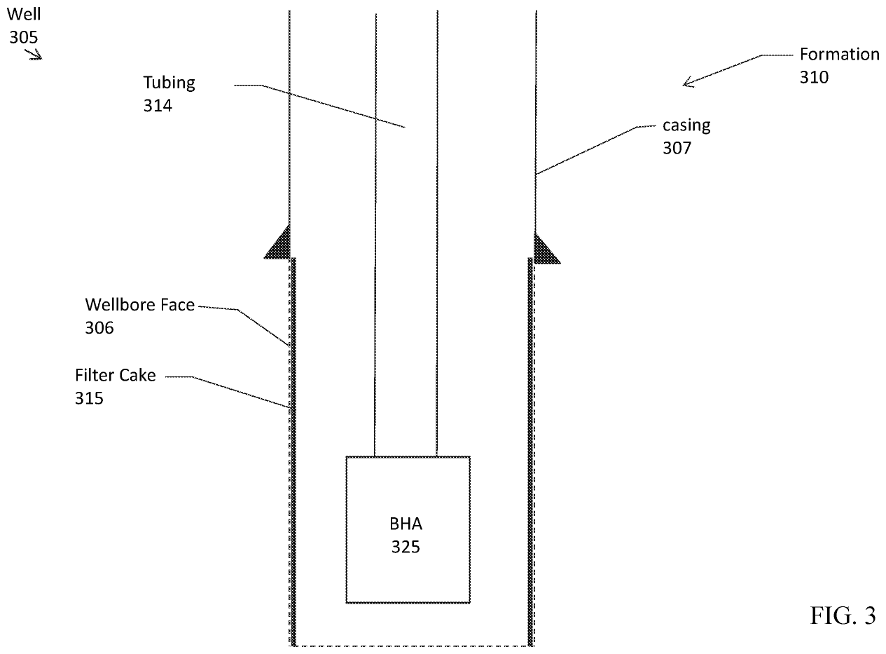

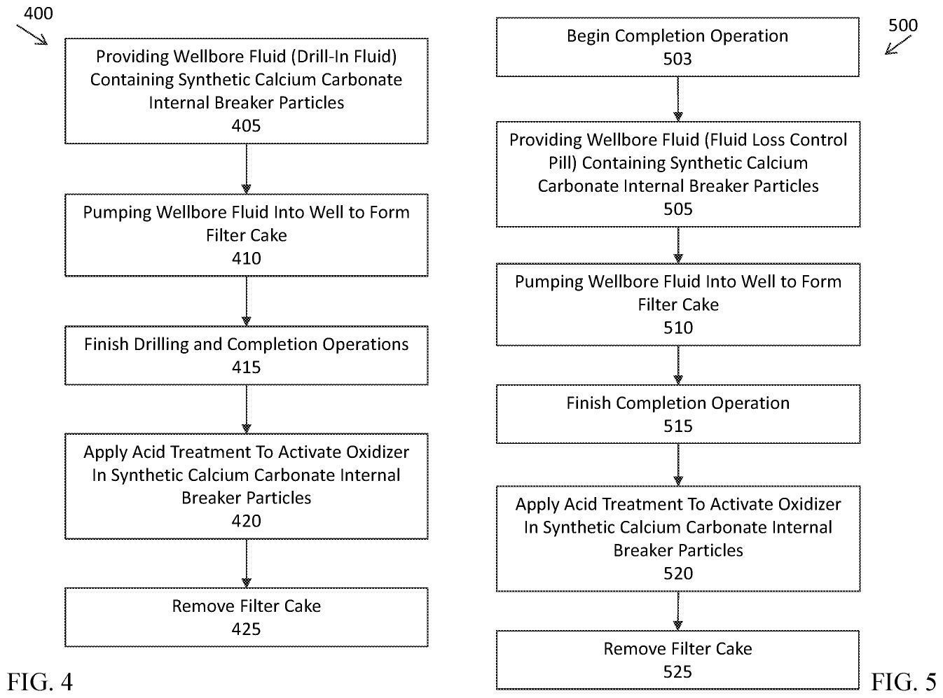

FIGS. 1A and 2A illustrate varying processes for manufacturing a wellbore fluid composition with synthetic calcium carbonate coated internal breaker particles that include sequestered carbon dioxide. FIGS. 1B and 2B illustrate the structure of the internal breaker particles that include synthetic calcium carbonate produced according to each associated manufacturing process. FIG. 3 illustrates a hydrocarbon well treated with a wellbore fluid composition comprising synthetic calcium carbonate coated internal breaker particles. FIG. 4 illustrates a method for treating a hydrocarbon well with a wellbore fluid composition that is a drill-in fluid in accordance with the example embodiments of this disclosure. FIG. 5 illustrates a method for treating a hydrocarbon well with a wellbore fluid composition that is a fluid loss control pill in accordance with the example embodiments of this disclosure.

Referring to FIG. 1A, an example method 100 is illustrated for manufacturing a wellbore fluid composition comprising synthetic calcium carbonate coated internal breaker particles. In step 102, a source of carbon dioxide is gathered for use in the method 100. The source of carbon dioxide can be air from the atmosphere or flue gas from the burning of a hydrocarbon.

In step 104, the carbon dioxide is brought into contact with an ammoniated aqueous solution. While the carbon dioxide source in step 102 is typically in gas form such as air or flue gas, it should be understood that the state of the carbon dioxide can be modified for the purpose of contacting with the aqueous solution. For example, the carbon dioxide brought into contact with the ammoniated aqueous solution can be in the state of a gas, a liquid, a solid, or a mixture of one of these states. The carbon dioxide source can be brought into contact with the ammoniated aqueous solution by bubbling carbon dioxide gas through the solution or by mixing solid or liquid forms of the carbon dioxide with the fluid flow of the ammoniated aqueous solution. The carbon dioxide reacts with the ammoniated aqueous solution and produces carbonic acid, bicarbonate ions, and carbonate ions. The presence of calcium ions in the aqueous solution allows for a greater concentration of the carbon dioxide to be sequestered. It should be understood that in alternate embodiments, other divalent cations such as magnesium ions, can be included in the aqueous solution. After the carbon dioxide is brought into contact with the ammoniated aqueous solution, the remaining carbon dioxide source gas, which has now been depleted of the carbon dioxide absorbed in step 104, is discharged in step 106 having less carbon dioxide than when it was the original source gas in step 102. Thus, step 104 removes carbon dioxide from the carbon dioxide source and discharges a depleted carbon dioxide gas in step 106.

In step 108, substrate particles are gathered for introducing into the carbonated aqueous solution produced in step 104. The substrate particles form the base of the synthetic calcium carbonate coated internal breaker particles and comprise one or more materials that assist in breaking down and removing a filter cake. The material of the substrate particles that will later break down the filter cake is typically an oxidizer, such as one or more peroxide compounds, including but not limited to magnesium peroxide or zinc peroxide. While not required, the substrate particles can comprise one or more other materials in addition to an oxidizer. For example, one or more other materials can be incorporated into the substrate particles to assist in maintaining the stability of the substrate particles. Maintaining the stability of the substrate particles is useful while forming the synthetic calcium carbonate coated internal breaker particles using method 100. The stability of the substrate particles is also important while the internal breaker particles are suspended in the wellbore fluid and while they are embedded in the filter cake until such time that the internal breaker particles are activated. The one or more other materials that may be incorporated into the substrate particles should be materials that can decompose or be dissolved so that they can be removed along with the break down and removal of the filter cake after completion of the wellbore operation. Examples of the one or more other materials that can be incorporated into the substrate particles include, but are not limited to, a) a naturally occurring mineral such as salt rock, ilmenite, or naturally occurring calcium carbonate; b) synthetic calcium carbonate particles formed previously by a process such as method 100, and c) a self-degrading polymeric material. The one or more other materials can be combined with the oxidizer in a variety of approaches. For example, the one or more additional materials may provide a nucleus for the oxidizer, they may form a protective coating around the oxidizer, or they may be blended with the oxidizer. The substrate particles can be designed to have a certain size or range of sizes in order for the synthetic calcium carbonate coated internal breaker particles produced by method 100 to have a size appropriate for use in a wellbore fluid composition.

Referring to step 110, the substrate particles are submerged in the aqueous solution containing carbonates from step 104. While the substrate particles are submerged in the aqueous solution, calcium carbonate compositions precipitate and form a coating of calcium carbonate on the exterior of the substrate particles. The precipitation of the calcium carbonate compositions can be controlled in various ways, including, for example, controlling the temperature of the aqueous solution so that it is in the range of 5 to 70 degrees C. In other examples, other properties of the aqueous solution that can be controlled in order to control precipitation include adjusting the pH of the aqueous solution so that it is in the range of 9 to 14. The result of step 110 is a collection of particles consisting of the substrate particles coated with the synthetic calcium carbonate created by process 100.

FIG. 1B provides a cross-sectional illustration of a synthetic calcium carbonate coated internal breaker particle produced in step 110. FIG. 1B shows the inner substrate particle 114 and the outer calcium carbonate coating 115. As described previously, the substrate particle 114 comprises the oxidizer and can comprise one or more other materials. The calcium carbonate forms a hard shell around the substrate particles and traps the carbon dioxide that was absorbed into the aqueous solution as described in connection with step 104. The calcium carbonate shell formed on the substrate particles increases the diameter of the particles. As an example, the size of the synthetic calcium carbonate coated internal breaker particles can be very fine, fine, medium, or coarse and can be in a range that is appropriate for use as an internal breaker in a wellbore fluid composition.

Referring to step 112 of FIG. 1A, the synthetic calcium carbonate coated internal breaker particles produced in step 110 are combined with other materials to produce a wellbore fluid composition. For example, other typical constituents of a wellbore fluid, such as a drill-in fluid composition or a fluid loss control pill, that can be combined with the synthetic calcium carbonate coated internal breaker particles include a base fluid, a viscosifier, a weighting agent, and a fluid loss control agent. The base fluid can be a brine solution, whereas the viscosifier and fluid loss control agents can be polymers. Weighting agents can be particles of calcium carbonate, barite, or other naturally occurring minerals. Furthermore, other components can be added to the wellbore fluid composition as appropriate for the particular conditions of a well, including one or more of: a pH control agent (such as magnesium oxide, sodium hydroxide, or potassium hydroxide), an oxygen scavenger, a clay inhibitor, a lubricant, and a biocide. The synthetic calcium carbonate coated internal breaker particles are typically present in the wellbore fluid at a concentration in the range of 0.5 to 5.0 lb/bbl and more preferably in a range of 0.5 to 2.0 lb/bbl.

The wellbore fluid produced in step 112 should have a pH in the range of 7.0 to 10.0 with a typical pH in the range of 8.5 to 9.5. Maintaining the pH of the wellbore fluid in one of the foregoing ranges will ensure that the synthetic calcium carbonate coating on the internal breakers does not dissolve while the particles are suspended in the wellbore fluid or while they are embedded in the filter cake. At a later stage after the particular wellbore operation, the particles will be exposed to an acidic solution causing the synthetic calcium carbonate coating to degrade, thereby releasing the oxidizer contained in the interior of the particles.

The calcium carbonate particles used for bridging and weighting in a wellbore fluid composition typically are a blend of particles having different sizes to effectively form a filter cake along the wellbore face of the formation to inhibit fluid flow into the pores of the formation. In some cases, the blend of particles can comprise conventional (naturally occurring) calcium carbonate particles as well as synthetic calcium carbonate coated internal breaker particles. While not required, a blend of particles having different sizes can be more effective at forming a filter cake to inhibit fluid loss into the pores of the formation. For example, the blend of particles can include coarse particles and very fine particles that combine to form an effective filter cake in the well. While the concentration of synthetic calcium carbonate coated internal breaker particles is a relatively small proportion of the wellbore fluid, they can have a size distribution or range similar to that of the bridging and weighting calcium carbonate particles in the wellbore fluid composition.

Each of the grade sizes of the calcium carbonate particles serving as a weighting agent as well as the calcium carbonate coated internal breaker particles can represent a size range for the particles within that grade. Accordingly, each of the grade sizes is a blend or distribution of particles within a particular size range. Thus, when two different grade sizes of particles are combined, it is a blend of two blends of particles. The following are typical numeric size ranges corresponding to the grade sizes of the calcium carbonate coated internal breaker particles and the calcium carbonate weighting agent particles:
Very fine: D50 of 3-8 microns
Fine: D50 of 9-15 microns
Medium: D50 of 16-50 microns
Coarse: D50 of 51-250 microns

The wellbore fluid composition produced by method 100 can be used for treating a well as described further in connection with FIGS. 3, 4, and 5. It should be understood that the example method 100 of FIG. 1A can be modified within the scope of this disclosure. For example, certain steps of method 100 may be altered. Moreover, additional steps may be added in sequence or in parallel to the method 100.

Referring now to FIG. 2A, a variation on the method of FIG. 1A is illustrated. Specifically, FIG. 2A illustrates example method 200. Example method 200 begins in the same manner as method 100 of FIG. 1A. Accordingly, it should be understood that steps 202 through 206 of FIG. 2A are substantially identical to steps 102 through 106 of FIG. 1A and the description of those steps applies to method 200 and will not be repeated. Additionally, step 208 is substantially identical to step 108 in that substrate particles comprising an oxidizer are gathered for coating with synthetic calcium carbonate. As in method 100 of FIG. 1A, the substrate particles gathered in step 208 can be solely oxidizer material or the oxidizer material can be combined with one or more other materials, such as materials that enhance the stability of the substrate particles.

Example method 200 differs from example method 100 in the preparation of the substrate particles that are to be coated with the synthetic calcium carbonate particles. In step 209, a protective coating is applied to encapsulate the substrate particles. For example, such a protective coating may be necessary to maintain the stability of the oxidizer material during the subsequent process of applying the synthetic calcium carbonate coating. In other words, the protective coating can prevent the oxidizer from reacting with the ammoniated aqueous solution, with carbon dioxide or, with the synthetic calcium carbonate coating that will be applied. The protective coating can be a polymer or other similar substance. As one example, the protective coating can be an enteric polymer for which solubility is dependent upon pH. During the method 200, the pH of the surrounding environment can be maintained in the range of 7.0 to 14.0 and preferably in the range of 9.0 to 14.0 so that the enteric polymer coating does not degrade.

In step 232, the substrate particles having the protective coating applied in step 209 are brought into contact with the carbonated aqueous solution and the synthetic calcium carbonate precipitates from the solution forming a coating that encapsulates the particles. FIG. 2B provides a cross-sectional illustration of the synthetic calcium carbonate coated internal breaker particle produced in step 232. As illustrated in FIG. 2B, the resulting particle comprises the substrate particle 214, which is encapsulated by an intermediate layer that is the protective coating 216 applied in step 209, which in turn is encapsulated by an outermost layer that is the synthetic calcium carbonate coating 215 applied in step 232.

One advantage of the outermost layer being the synthetic calcium carbonate coating 215 is that the material can withstand high temperatures. It is common to encounter high temperatures in the range of 250 F to 400 F at the significant depths to which hydrocarbon producer wells or injector wells are drilled. If the substrate particle simply had the polymer coating 216, most polymers will melt in the temperature range of 250 F to 400 F. Accordingly, a polymer coating would be insufficient in maintaining the oxidizer of the substrate in an inert state while it is pumped into the well and embedded in the filter cake. However, because the synthetic calcium carbonate coating 215 will remain in a solid state at temperatures in the range of 250 F to 400 F, the synthetic calcium carbonate coating 215 is advantageous at maintaining the oxidizer in an inert state while it pumped into the well and embedded in the filter cake.

Referring to step 234, the synthetic calcium carbonate coated internal breaker particles produced in step 232 are combined with other materials to produce a wellbore fluid composition. For example, other typical constituents of a wellbore fluid composition that can be combined with the synthetic calcium carbonate particles include a base fluid, a viscosifier, a weighting agent, and a fluid loss control agent. The base fluid can be a brine solution, whereas the viscosifier and fluid loss control agents can be polymers. Weighting agents can be particles of calcium carbonate, barite, or other naturally occurring minerals. Furthermore, other components can be added to the wellbore fluid composition as appropriate for the particular conditions of a well, including a pH control agent (such as magnesium oxide, sodium hydroxide, or potassium hydroxide), an oxygen scavenger, a lubricant, and a biocide. Additionally, the discussion associated with FIG. 1A concerning the size distributions of the synthetic calcium carbonate coated internal breaker particles is equally applicable to the embodiment of FIGS. 2A and 2B.

The wellbore fluid composition produced in step 234 can be used for treating a well as described further in connection with FIGS. 3, 4, and 5. It should be understood that the example method 200 of FIG. 2A can be modified within the scope of this disclosure. For example, certain steps of method 200 or the components used in the method 200 may be altered. Moreover, additional steps may be added in sequence or in parallel to the method 200.

FIGS. 3, 4, and 5 illustrate methods for treating a well with a wellbore fluid composition such as the compositions produced by the methods illustrated in FIGS. 1A and 2A. As explained previously, wellbore fluids can be used during various operations performed on the well, including drilling, completion, and workover operations. The wellbore fluid can assist with one or more of maintaining the wellbore, removing cuttings, protecting the wellbore face of the formation during the various operations, and inhibiting fluid flow between the wellbore and the formation.

Referring now to FIG. 3, a cross-section of a well 305 is illustrated. Well 305 can be located on land or could be a deepwater well. Well 305 is defined by a wellbore having wellbore face 306 along a formation 310 that comprises a hydrocarbon reservoir or a formation where fluids will be injected (not shown). The well 305 comprises a casing 307 proximate the well opening, but the portion of the well below the casing 307 is an open hole such that the wellbore face 306 is exposed to the well. In a drilling operation, the tubing 314 can be a drill string through which drilling fluids are pumped to facilitate the drilling operation. At the end of the drill string is a bottom hole assembly (BHA) 325 comprising the drilling equipment used to drill the well 305. In other wellbore operations other types of equipment can be attached to the tubing 314.

As the BHA 325 passes through the reservoir zone of the formation, the drilling fluid pumped through the tubing 314 can be a drill-in fluid specifically designed to protect the formation in the reservoir zone. The drill-in fluid can be a drill-in fluid composition such as the compositions described in connection with FIGS. 1A and 2A. When pumped into the well through the tubing 314, the drill-in fluid comes into contact with the exposed wellbore face 306 and performs a bridging function whereby the calcium carbonate particles create a filter cake 315. The filter cake 315 along the exposed wellbore face 306 protects the reservoir zone of the formation and inhibits fluid flow into reservoir zone of the formation. The drill-in fluid also comprises synthetic calcium carbonate coated internal breaker particles such as those particles produced in connection with the methods of FIGS. 1A and 2A. As the filter cake 315 is formed along the wellbore face 306, the synthetic calcium carbonate coated internal breaker particles are embedded in the filter cake for later activation.

FIG. 4 illustrates an example method 400 for performing a wellbore operation in a reservoir zone of a formation using a wellbore fluid composition such as those produced by the example methods of FIGS. 1A and 1B. In step 405, a wellbore fluid composition, such as a drill-in fluid, is provided. The wellbore fluid composition can include weighting and bridging particles, such as calcium carbonate particles, and synthetic calcium carbonate coated internal breaker particles. In step 410, the wellbore fluid composition is pumped into the well in connection with a drilling operation in a reservoir zone. For example, the wellbore fluid composition can be pumped into well 305 using tubing 314 so that the wellbore fluid composition contacts the wellbore face 306 along the reservoir zone of the formation 310. The wellbore fluid forms a filter cake 315 along wellbore face 306 that protects the reservoir zone while the operation proceeds. Embedded in the filter cake are the synthetic calcium carbonate coated internal breaker particles.

With the filter cake in place, the pores of the formation in the reservoir zone are protected and the wellbore operation, such as drilling and completion operations, can be completed in step 415. Once the operation is finished, in step 420 an acid treatment is pumped into the well to break down and remove the filter cake. The acid or chemical treatment can dissolve the calcium carbonate particles of the filter cake. Additionally, the acid treatment can dissolve the synthetic calcium carbonate that forms the outer coating of the synthetic calcium carbonate coated internal breaker particles. If the internal breaker particles include an intermediate protective coating, the acid or chemical treatment can be designed to dissolve the intermediate coating as well. With the outer coating, and if present the intermediate coating, dissolved, the oxidizer within the internal breaker particles is released and can react with the other particles of the filter cake to assist with breaking down the filter cake. If the substrate of the internal breaker particles comprises additional materials, as explained previously, those additional materials will also dissolve in the presence of the acid treatment. Once the filter cake breaks down, in step 425, it can be easily removed from the wellbore face 306. It should be understood that method 400 is only one illustrative example and in alternate embodiments certain steps of method 400 may be altered.

Referring now to FIG. 5, another example method 500 is illustrated. Method 500 is similar to method 400 but describes using a wellbore fluid that is a fluid loss control pill. In step 503, a completion operation, such as a perforation or placement of a sand screen or gravel pack, begins on a well. In step 505, a wellbore fluid composition, such as a fluid loss control pill, is provided. The wellbore fluid composition can include weighting and bridging particles, such as calcium carbonate particles, and synthetic calcium carbonate coated internal breaker particles. In step 510, the wellbore fluid composition is pumped into the well in connection with the completion operation in a reservoir zone. For example, if fluid losses are detected that exceed a limit, the wellbore fluid composition can be a fluid loss control pill pumped into the well to mitigate the fluid losses. For example, the wellbore fluid composition can be pumped into the well so that the wellbore fluid composition contacts the wellbore face along the reservoir zone of the formation, or along a sand screen or gravel pack. The wellbore fluid forms a filter cake along the wellbore face, or the sand screen or gravel pack, that mitigates fluid loss. Embedded in the filter cake are the synthetic calcium carbonate coated internal breaker particles.

Once the completion operation is finished in step 515, an acid or chemical treatment is pumped into the well to break down and remove the filter cake in step 520. The acid or chemical treatment can dissolve the calcium carbonate particles of the filter cake. Additionally, the acid treatment can dissolve the synthetic calcium carbonate that forms the outer coating of the synthetic calcium carbonate coated internal breaker particles. If the internal breaker particles include an intermediate protective coating, the acid or chemical treatment can be designed to dissolve the intermediate coating as well. With the outer coating, and if present the intermediate coating, dissolved, the oxidizer within the internal breaker particles is released and can react with the other particles of the filter cake to assist with breaking down the filter cake. If the substrate of the internal breaker particles comprises additional materials, as explained previously, those additional materials will also dissolve in the presence of the acid treatment. Once the filter cake breaks down, in step 525, it can be easily removed. It should be understood that method 500 is only an illustrative example and in alternate embodiments certain steps of method 500 may be altered.

For any figure shown and described herein, one or more of the components may be omitted, added, repeated, and/or substituted. Accordingly, embodiments shown in a particular figure should not be considered limited to the specific arrangements of components shown in such figure. Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure.

With respect to the example methods described herein, it should be understood that in alternate embodiments, certain steps of the methods may be performed in a different order, may be performed in parallel, or may be omitted. Moreover, in alternate embodiments additional steps may be added to the example methods described herein. Accordingly, the example methods provided herein should be viewed as illustrative and not limiting of the disclosure.

Terms such as “first”, “second”, “top”, “bottom”, “side”, “distal”, “proximal”, and “within” are used merely to distinguish one step or component from another. Such terms are not meant to denote a preference or a particular orientation, and are not meant to limit the embodiments described herein. In the example embodiments described herein, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The terms “a,” “an,” and “the” are intended to include plural alternatives, e.g., at least one. The terms “including”, “with”, and “having”, as used herein, are defined as comprising (i.e., open language), unless specified otherwise.

Various numerical ranges are disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. Numerical end points of ranges disclosed herein are approximate, unless excluded by proviso.

Values, ranges, or features may be expressed herein as “about”, from “about” one particular value, and/or to “about” another particular value. When such values, or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means ±20% of the stated value, ±15% of the stated value, ±10% of the stated value, ±5% of the stated value, ±3% of the stated value, or ±1% of the stated value.

Although embodiments described herein are made with reference to example embodiments, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

1. A method of making synthetic calcium carbonate coated internal breaker particles for use in a wellbore fluid composition, the method comprising:
contacting an ammoniated aqueous solution with a carbon dioxide source producing a carbonated ammoniated aqueous solution; and
contacting the carbonated ammoniated aqueous solution with substrate particles to produce synthetic calcium carbonate coated internal breaker particles, wherein the substrate particles are coated with synthetic calcium carbonate and the substrate particles comprise an oxidizer.

2. The method of claim 1, further comprising:
combining the synthetic calcium carbonate coated internal breaker particles with a base fluid, a viscosifier, a fluid loss control agent, a weighting agent, and a pH control agent to produce the wellbore fluid composition.

3. The method of claim 2, wherein the synthetic calcium carbonate coated internal breaker particles are present in the wellbore fluid composition at a concentration within a range of 0.5 to 5.0 lb/bbl.

4. The method of claim 1, wherein the substrate particles further comprise one of: a) synthetic calcium carbonate, b) a naturally occurring mineral, and c) a self-degrading polymeric material.

5. The method of claim 1, wherein the substrate particles further comprise a protective coating surrounding the oxidizer.

6. The method of claim 1, wherein the synthetic calcium carbonate coated internal breaker particles can withstand a temperature within a range of 250 F to 400 F when pumped into a well.

7. The method of claim 1, wherein the oxidizer is activated when the synthetic calcium carbonate coated internal breaker particles are exposed to an acid.

8. A composition of synthetic calcium carbonate coated internal breaker particles comprising:
substrate particles, each of the substrate particles comprising an oxidizer; and
a coating of synthetic calcium carbonate surrounding each of the substrate particles, wherein the coating of synthetic calcium carbonate is formed by:
contacting an ammoniated aqueous solution with a carbon dioxide source producing a carbonated ammoniated aqueous solution; and
contacting the carbonated ammoniated aqueous solution with the substrate particles to produce the composition of synthetic calcium carbonate coated internal breaker particles.

9. The composition of claim 8, wherein the composition of synthetic calcium carbonate coated internal breaker particles is a constituent of a wellbore fluid, the wellbore fluid composition further comprising:
a base fluid;
a viscosifier;
a fluid loss control agent;
a weighting agent; and
a pH control agent.

10. The composition of claim 9, wherein the synthetic calcium carbonate coated internal breaker particles are present in the wellbore fluid composition at a concentration within a range of 0.5 to 5.0 lb/bbl.

11. The composition of claim 8, wherein the substrate particles further comprise one of: a) synthetic calcium carbonate, b) a naturally occurring mineral, and c) a self-degrading polymeric material.

12. The composition of claim 8, wherein the substrate particles further comprise a protective coating surrounding the oxidizer.

13. The composition of claim 8, wherein the synthetic calcium carbonate coated internal breaker particles can withstand a temperature within a range of 250 F to 400 F when pumped into a well.

14. The composition of claim 8, wherein the oxidizer is activated when the synthetic calcium carbonate coated internal breaker particles are exposed to an acid.

15. A method of protecting a formation during an operation on a well, the method comprising:
forming a blend of calcium carbonate particles, wherein at least a portion of the blend of calcium carbonate particles are synthetic calcium carbonate coated internal breaker particles formed from captured carbon dioxide;
combining the blend of calcium carbonate particles with a base fluid, a viscosifier, a weighting agent, and a fluid loss control agent to produce a wellbore fluid composition; and
pumping the wellbore fluid composition into the well to a location adjacent to a reservoir zone of the formation.

16. The method of claim 15, wherein the wellbore fluid composition forms a filter cake on a wellbore face of the formation.

17. The method of claim 16, wherein the synthetic calcium carbonate coated internal breaker particles comprise a substrate coated with synthetic calcium carbonate, wherein the substrate comprises an oxidizer and a naturally occurring calcium carbonate.

18. The method of claim 17, further comprising pumping an acid composition into the well, wherein the acid composition dissolves the synthetic calcium carbonate and releases the oxidizer from the synthetic calcium carbonate coated internal breaker particles.

19. The method of claim 17, wherein the oxidizer and the naturally occurring calcium carbonate of the substrate are coated with a polymer before the coating with the synthetic calcium carbonate is applied.

20. The method of claim 16, wherein the synthetic calcium carbonate coated internal breaker particles can withstand a temperature within a range of 250 F to 400 F when pumped into a well.
